(19) United States
(12) Patent Application Publication
(10) Pub. No.: US 2017/0322923 A1
(43) Pub. Date: Nov. 9, 2017

(54) TECHNIQUES FOR DETERMINING TEXTUAL TONE AND PROVIDING SUGGESTIONS TO USERS

(71) Applicant: Google Inc., Mountain View, CA (US)

(72) Inventors: Lucas Gill Dixon, Brooklyn, NY (US); Peter Junteng Liu, Mountain View, CA (US); Ambarish Jash, Palo Alto, CA (US); Deepa Vivekanandan, Mountain View, CA (US); Christopher John Adams, Brooklyn, NY (US); Andrew Mingbo Dai, San Francisco, CA (US)

(73) Assignee: Google Inc., Mountain View, CA (US)

(21) Appl. No.: 15/146,061

(22) Filed: May 4, 2016

(51) Int. Cl. G06F 17/27; G06N 5/04; G06N 99/00

(52) U.S. Cl. CPC G06F 17/279; G06N 99/005; G06F 17/274; G06N 5/04

(57) ABSTRACT

A computer-implemented technique can include obtaining a vector-based language model associating elements of an unlabeled corpus that have similar meanings, training a machine-learning classifier using the vector-based language model and a labeled corpus of text that has been annotated as having a particular level of abusiveness, obtaining a text, determining a prediction for the text using the machine-learning classifier, the prediction being indicative of a level of abusiveness of the text, and based on the level of abusiveness of the text, selectively outputting a recommended action with respect to the text.

### FIELD

The present disclosure relates generally to online discussion systems and, more particularly, to techniques for determining textual tone and providing suggestions to users.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The goal of online discussion systems (message boards, comment threads, etc.) is for textual discussions to have a sufficiently constructive tone. These discussions however, often devolve into acrimonious arguments. The causes of this are incendiary remarks from participating users, which can structural (e.g., duplicative statements) and/or tone-related (e.g., overly emotional), and may result in moderators limiting or shutting down online discussion systems.

### SUMMARY

A computer-implemented technique is presented. The technique can include obtaining, by a computing system having one or more processors, a vector-based language model associating elements of an unlabeled corpus that have similar meanings; training, by the computing system, a machine-learning classifier using the vector-based language model and a labeled corpus of text that has been annotated as having a particular level of abusiveness; obtaining, by the computing system, a text; determining, by the computing system, a prediction for the text using the machine-learning classifier, the prediction being indicative of a level of abusiveness of the text; and based on the level of abusiveness of the text, selectively outputting, by the computing system, a recommended action with respect to the text.

A computing system having one or more processors and a non-transitory memory is also presented. The memory can have instructions stored thereon that, when executed by the one or more processors, causes the computing system to perform operations. The operations can include obtaining a vector-based language model associating elements of an unlabeled corpus that have similar meanings; training a machine-learning classifier using the vector-based language model and a labeled corpus of text that has been annotated as having a particular level of abusiveness; obtaining a text; determining a prediction for the text using the machine-learning classifier, the prediction being indicative of a level of abusiveness of the text; and based on the level of abusiveness of the text, selectively outputting a recommended action with respect to the text.

In some embodiments, the vector-based language model utilizes at least one of word vectors and paragraph vectors. In some embodiments, the technique or operations further comprise: determining, by the computing system, a score for the text using the machine-learning classifier, the score being indicative of the determined level of abusiveness; and determining, by the computing system, the prediction for the text by comparing the score to one or more thresholds indicative of varying levels of abusiveness. In some embodiments, repetitive text and overly aggressive text are both indicative of a lower level of abusiveness. In some embodiments, training the machine-learning classifier involves utilizing a deep recurrent long short-term memory (LSTM) neural network.

In some embodiments, the computing system obtains the text while a user is typing the text and before the text has been published at an online discussion system; and when the score is greater than a writing threshold, the recommended action is a suggestion for the user to revise the text prior to its publication at the online discussion system. In some embodiments, the computing system obtains the text before it loads at the computing device; and when the score is greater than a viewing threshold, the recommended action is for the text to be hidden. In some embodiments, the technique or operations further comprise: obtaining, by the computing system, feedback regarding an accuracy of the determined level of abusiveness; and updating, by the server, the machine-learning classifier based on the feedback.

In some embodiments, the recommended action is with respect to publishing the text, and the computing system obtains the text when it is submitted by its author for publishing at an online discussion system; and the technique or operations further comprise: based on the score and a publication threshold indicative of a level of abusiveness for publication without moderator review, selectively publishing, by the computing system, the text at the online discussion system. In some embodiments, the technique or operations further comprise when the score is less than or equal to the publication threshold, publishing, by the computing system, the text at the online discussion system; when the score is greater than the publication threshold, outputting, from the computing system and to a computing device associated with the a moderator of the online discussion system, the text; and selectively publishing, by the computing system, the text at the online discussion system based on a response from the computing device.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system configured to determine textual tone and provide suggestions to users according to some implementations of the present disclosure; and

FIG. 2 is a flow diagram of an example technique for determining textual tone and providing suggestions to users according to some implementations of the present disclosure.

### DETAILED DESCRIPTION

In order to have a sufficiently constructive tone for a textual discussion, emotion does not need to be removed from the dialogue. Instead, the goal is to help the participating users avoid making incendiary remarks, which often cause participating users to attack the form of the textual discussion instead of its substance. As previously mentioned, incendiary remarks can be structural (e.g., repetitive statements) and/or tone-based (e.g., overly aggressive). Therefore, there is a need to determine textual tone in order to identify potentially problematic language.

One of the primary challenges is how to understand the emotional impact of language (when is it insulting, when is it passive aggressive, etc.). The terms “abuse” and “abusiveness” are used in referring to a tone or attitude for a portion of text. Abusive language, or text having an inappropriate tone, may include disrespectful language (e.g., harsh or insulting language), but it is not limited thereto. For example, a passive aggressive tone could be abusive. Abuse or abusive language can also refer to language that does not comply with a set of rules or guidelines (e.g., for an online discussion forum). Conventional moderation, for example, often involves identifying text using bad word lists (e.g., swear words) or spam checkers, but such techniques fail to identify incendiary remarks that do not contain words from these lists. Manual moderation by one or more human moderators, on the other hand, is too slow and can be very expensive.

Accordingly, techniques are presented for determining textual tone and providing suggestions to users. Once textual tone has been determined, suggestions can be provided to the participating users to help them avoid making incendiary remarks. The textual tone can be determined automatically using a machine-learned classifier. Initially, a computing system can obtain a vector-based language model. The vector-based language model (word vectors, paragraph vectors, etc.) can associate elements of an unlabeled corpus that have similar meanings. More specifically, a metric on vectors (e.g., cosign similarity) can provide a notion of how similar the interpretation of the vectors are. This vector-based language model could be pre-generated or could be generated by the computing system using the unlabeled corpus. The computing system can then train a machine-learning classifier using the vector-based language model and a labeled corpus of user comments that have been manually annotated as having a particular level of abusiveness.

The terms “abuse” and “abusiveness” as used herein can refer to what an average or aggregate user would classify a tone of a particular text. This is because the machine-learning or machine-learned classifier can be trained using a plurality of annotated examples, and can be further refined using user feedback. The terms abuse/abusiveness tone could also mean, for example only, respectful vs. disrespectful tone, constructive vs. destructive tone, productive vs. unproductive tone, sensible vs. impractical tone, reasonable vs. unreasonable tone, and rational vs. irrational tone. A level of abusiveness could also be indicative of different types of tone (passive aggressive, hate, sarcastic, etc.). For example, thresholds could be utilized to classify the tone via a comparison to the level of abusiveness (e.g., a score).

The computing system can obtain a text. For example, the text may be associated with a user and an online discussion system. This text could be being written/authored, could be submitted for publishing, or could be published and being loaded for viewing/reading. The text could also be retrieved from other sources, such as an online datastore. The computing system can determine a prediction for the text using the machine-learning classifier, the prediction being indicative of the level of abusiveness of the text, e.g., corresponding to the average user. Then, based on the level of abusiveness of the text, the computing system can selectively output a recommended action. For example, this recommended action could be a suggestion output to a computing device associated with the user, such as a suggestion for the text to be edited. Non-limiting examples of the recommended action can include revising the text, filtering or hiding the text prior to viewing/reading, or for a moderator to further review the text prior to publishing.

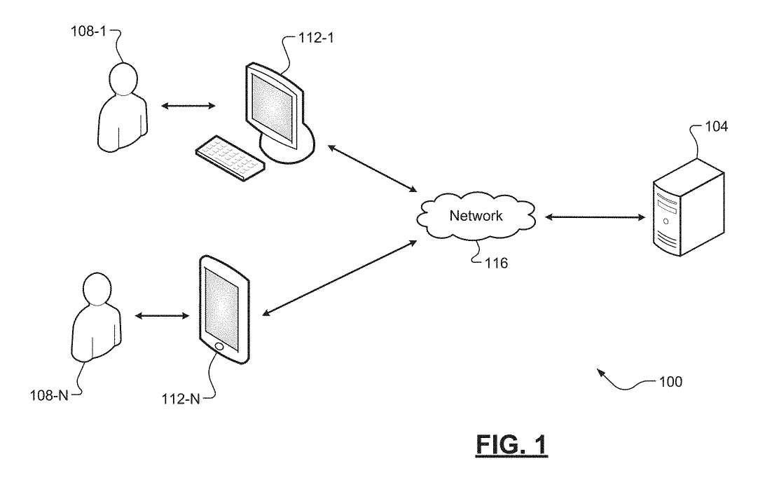

Referring now to FIG. 1, a diagram of an example computing system 100 is illustrated. The computing system 100 can be configured to determine textual tone and provide user suggestions according to some implementations of the present disclosure. A server 104 can obtain a language model using an unlabeled corpus and can train a machine-learning classifier using the language model and a labeled corpus of user comments. While a single server 104 is shown and discussed herein, it will be appreciated that a plurality of servers could be implemented. For example, one set of servers may be configured to obtain and implement the machine-learning classifier and another set of servers may be associated with an online discussion system, such as a message board or comment thread. The machine-learning classifier can be utilized by the server 104 to determine textual tone and provide suggestions to users 108-1 . . . 108-N (N≧1, collectively, “users 108”) at their respective computing devices 112-1 . . . 112-N (collectively “computing devices 112) via a network 116 (e.g., the Internet).

Examples of the computing devices include, but are not limited to, desktop computers, laptop computers, tablet computers, and mobile phones. In one implementation, the computing devices 112 may provide application program interface (API) calls to the server 104. More specifically, the server 104 can obtain a text associated with an online discussion system (a text being typed for posting, a posted text being read, etc.) and can analyze the text using the machine-learning classifier to identify the tone and provide a helpful user suggestion. A basic language model can be obtained via unsupervised machine learning on a large unannotated corpus of text, e.g., comment strings or entire web pages. The desired output is that the basic language model provides a sufficiently high level and abstract set of features for then carrying out supervised learning on a relatively small set of annotated examples.

In some implementations, vectors-based approaches can be utilized to build the basic language model. Two types of vector-based models that could be utilized are word vectors and paragraph vectors. Word vectors can refer to the development of a probabilistic model of documents which learn word representations without requiring labeled data. Paragraph vectors, on the other hand, can refer to an unsupervised framework that learns continuous distributed vector representations for pieces of text, ranging from sentences to entire documents. Vector-based models can provide some convenient characteristics, e.g., the meanings of the sequential concatenation of chunks of language can be modeled by composition of the underlying vectors. It will be appreciated, however, that other vector-based models could be utilized to obtain the basic language model.

As previously mentioned, by using an unsupervised training for the language model, only a small set of annotated examples are needed to create and train the classifier for disrespectful language. For example only, a few thousand training examples may lead to reasonable results. One example of the corpus of annotated comments is a set of manually reviewed comments of a comment thread that are annotated with whether they are problematic or not. Other training corpora could also be utilized. The training corpus/corpora could also be pre-analyzed, such as by parsing or entity abstraction. After training, the trained machine-learning classifier can be utilized for automatically determining textual tone in order to provide user suggestions.

The machine learnt feature of the language model that can be utilized to identify disrespectful language is also referred to herein as a respect classifier. Example techniques for creating such a classifier on top of the features provided by the unsupervised language model include, but are not limited to, support vector machines (SVMs) and neural networks. In some implementations, sentences can be fed to the language model to obtain a meaning-vector for the chunk of text, but it should be appreciated that other units of annotated text could be input (a phrase, a paragraph, a document, etc.). This can produce a single meaning vector for the chunk of text, which can be used as the set of features given to the abusiveness classifier's training example.

Each training example can be annotated with a set of labels for the types of abusive language it contains. Examples of labels for manually annotated chunks of text include, but are not limited to, hateful, harassing, racist, misogynistic, cynical, passive aggressive, sexual content, and targeting a group. The closer are that these categories are to linguistic features, the better the machine-learning classifier can be. Optionally, these training examples could also be given a score for how relatively significant they are (e.g., between 0 and 1). A binary annotation could also be applied (e.g., abusive or non-abusive). As previously mentioned, to create the initial abuse classifier, even a rather approximate dataset could be utilized. For example, policy violations for a message board or comment thread could be utilized to create the initial abuse classifier, which could then be improved using user-generated data, corrections, and further re-training. User feedback of the annotations can be used to further refine the abuse classifier (e.g., a user correction of a machine score).

As the number of training examples increases, the topology of the learning pipeline can be modified. Initially, the abuse classifier can be trained directly on a single vector output from the unsupervised language model. When the underlying language model emits a sequence of vectors, e.g. a vector for each word, however, as word vectors does, a deep neural network (e.g. a recurrent long short-term memory, or LSTM neural network) can be used to compose the meanings of the lower level vectors instead of doing the more naive vector composition. This can be helpful as the size of the training data increases. As more data is obtained, the neural networks can be allowed to take on more responsibility in the classification task.

When the number of examples is large, e.g., in the hundreds of thousands, a deep LSTM neural network can be used directly on the text. This can allows the neural network to take account of finer grained learning of the semantics in the annotated examples. While this is not performed at start because there are insufficiently many training examples, as more data is collected, the machine learning models can handle more complexity. While a deep neural network with LSTM is the proposed approach and is explicitly discussed herein, it will be appreciated that other suitable deep learning methods could also be utilized.

In some implementations, the abuse classifier can be implemented as a web service API. While the classifier is referred to as a abuse classifier herein, it should be appreciated that the machine-learning classifier can generate a non-abusiveness score (or a “goodness” score) for a chunk of text. In other words, the higher the score, the more appropriate or respectful the text. By breaking down the text into chunks, e.g., 10 and 5-word blocks (optionally, respecting sentence structure), and then feeding multiple chunks, e.g., 3 chunks, at a time into the abuse classifier, a particular problematic region of the text can be identified that still takes account of context, while also providing more detailed granularity for where the problematic text occurs.

The client could send the whole text, or chunks of the text, and the server 104 can act in a uniform manner sending back the areas of the text that are problematic annotated by the region. The size to break chunks into can be specified in the protocol. Chunking is also beneficial because it allows user-level feedback on which parts of the text are problematic. The more fine-grained feedback can provide better annotations of the underlying that can be used to improve the abuse classifier. Instead of using chunking, a recurrent network for machine learning can allow output to be given a much finer level of granularity. The recurrent LSTM approach discussed above simply gives an output at each word (OK, Insulting, Insulting & Sarcastic, etc.). Hypertext transfer protocol (HTTP) GET requests could be used to get abuse classifier results. To send annotation from a user that can be used to improve the machine learning model, an HTTP PUT request could be sent.

Such an API can allow a lightweight client (e.g., a small memory footprint and quick to download) to utilize the abuse classifier via a web browser. A client can send queries to the web service to obtain annotation for the text, and can also send user-generated annotations to the web service. The web service can add user-provided annotations to the corpus of trained examples. A respect web-service such as this can allow a wide variety of user interfaces (UIs) to be built. To allow or enable offline usage, the machine-learning classifier could also be compressed and stored and used within a client application (e.g., an operating system or a web browser). The abuse classifier could then be called directly from within the client. Annotations to be sent to the web service could then be queued until the client has network connectivity.

As previously mentioned, the machine-learning classifier could be implemented in a wide array of front-end tools. Using the abuse classifier functionality, any text can be checked for a level of abusiveness. This can be done on a selected text fragment, or as an author is typing (e.g., similar to a spell-checking like functionality), as a user is viewing text (e.g., a comment thread), or after text is written and submitted to an Internet platform (e.g., social media or an online forum). Another potential implementation is a game where users are showed some text and are allowed to submit it to the abuse classifier to be checked. This can be done out of curiosity, such as to check something being written for another platform (e.g., email) or to subsequently check the abusiveness service's score (e.g., against a game threshold) and potentially submit corrective feedback.

For the real-time authoring scenario, when a user is authoring some text (an email, a comment in a thread, a social media post, a document, etc.), respect checking can be performed in a similar manner to spell checking. That is, each time a new word is typed, the relevant text content and contextual values can be sent to the web-service API and compared to a writing threshold. This can then be used to identify potentially problematic tone and generate suggestions with respect thereto. In some implementations, checking could be done periodically instead of after every word. For example only, the user could be authoring the following text:
Could I ask you to show a bit more empathy for the people who these discussion are intended to help rather than focusing on the almost completely hypothetical harm to you? . . . Sorry, I keep forgetting that you are the victim in all this.

The machine-learning classifier could be utilized to identify the text portion “Could I ask you to show a bit more empathy . . . rather than focusing on the almost completely hypothetical harm to you?” as an accusation that the recipient is only thinking of themselves. A suggestion could be “If you are feeling upset, you may be better off saying ‘I feel upset as I read . . . [and reference the text that you feel bad about].” Similarly, the machine-learning classifier could be utilized to identify the text portion “Sorry, I keep forgetting that you are the victim in all this” as coming across as sarcastic and insulting. A suggestion could be to remove it from the text.

For the viewing/reading scenario, an existing platform with textual contributions (a message board, a comment thread, etc.) could offer a filtering service to users (e.g., using a viewing threshold). More particularly, a user can select a class of comments (e.g., according to the classes trained in the abuse classifier) that they wish not to see. The platform can then hide comments in the selected categories. For example, a user viewing a comment thread could ask to hide comments that are hateful and the following text could be part of a comment in the thread: “Wow you a-holes r truly the ones behind terrorism trying to manipulate and brain wash the public with ur comedy of what is a serious matter.” The machine-learning classifier could be utilized to identify the entire phrase as hateful (e.g., because it includes the word “a-holes”) and a suggestion could be provided to hide hateful text such as this. This analysis could be performed during loading of a web page, for example, and thus the suggestions could be ready while the user is reading or, in some cases, certain content could be pre-filtered before reaching the user.

For the moderation scenario, there can be a threshold over/under which a particular text can be send for review and/or a threshold over/under which a particular text will not appear until it is reviewed (e.g., one or more publication thresholds). The operations of such threshold(s) depends on whether the abuse classifier is trained to output a score indicative of non-abusiveness (e.g., less than a particular threshold) or abusiveness (e.g., greater than a particular threshold). These threshold(s) can be used as a form of moderation (automated, plus manual review) as well as a way to encourage users to write better text. For example, the text above with respect to terrorism could be identified as hateful extremist language and a human moderator may be provided a suggestion to confirm the classification or update the annotations, and additionally or alternatively confirming or updating the score. In some cases, a text may never be posted or otherwise publicized when its abusiveness score exceeds the publication threshold, unless it is subsequently reviewed and approved by the moderator.

With respect to the computing system 100 of FIG. 1, client queries can be sent to the server 104 from the computing devices 112 to determine scores for texts. The server 104 can implement, for example, the web service API for calling the machine-learning classifier. As previously discussed, such queries can be generated while the text is being authored or when text is loaded (i.e., before the text is read). Thresholds can also be implemented for when to send text to a moderator for manual review. In some implementations, the machine-learning classifier can be built directly into an application as opposed to being implemented as a web service API as discussed herein. In other implementations, the machine-learning classifier could be configured for speech recognition to moderate spoken language.

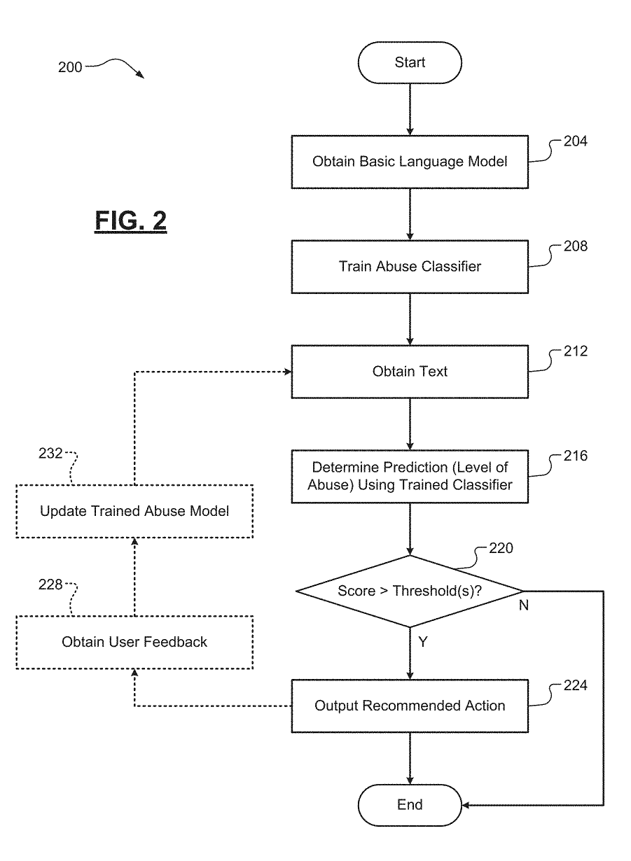

Referring now to FIG. 2, a flow diagram of an example technique 200 for determining textual tone and providing user suggestions is illustrated. While the technique 200 is described as being implemented by a computing system (e.g., computing system 100), it will be appreciated that the technique 200 can be primarily implemented at the server 104 or at a system of servers. At 204, the computing system can obtain a language model using an unlabeled corpus. For example, this initial model can be a basic language model. At 208, the computing system can train a machine-learning classifier of the language model and a labeled corpus of user comments that have been manually annotated as having a particular level of abusiveness. At 212, the computing system can obtain a text associated with an online discussion system. At 216, the computing system can determine a prediction for the text using the machine-learning classifier. The prediction can be indicative of a level of abusiveness (e.g., an abusiveness score) of the text. At 220, the computing system can compare the abusiveness score to threshold(s) for providing user suggestions. When the abusiveness score is indicative of an abusive or otherwise inappropriate tone and a user suggestion is appropriate, the computing system can output, to a computing device associated with a user, a recommended action (e.g., a suggestion for the user with respect to the determined tone of the text) at 224. The technique 200 can then end or, optionally, user feedback can be obtained by the computing system at 228 and used to update the machine-learning classifier at 232 before returning to 212.

Further to the descriptions above, a user may be provided with controls allowing the user to make an election as to both if and when systems, programs or features described herein may enable collection of user information (e.g., information about a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method comprising:
obtaining, by a computing system having one or more processors, a vector-based language model associating elements of an unlabeled corpus that have similar meanings;
training, by the computing system, a machine-learning classifier using the vector-based language model and a labeled corpus of text that has been annotated as having a particular level of abusiveness;
obtaining, by the computing system, a text;
determining, by the computing system, a prediction for the text using the machine-learning classifier, the prediction being indicative of a level of abusiveness of the text; and
based on the level of abusiveness of the text, selectively outputting, by the computing system, a recommended action with respect to the text.

2. The computer-implemented method of claim 1, wherein the vector-based language model utilizes at least one of word vectors and paragraph vectors.

3. The computer-implemented method of claim 1, further comprising:
determining, by the computing system, a score for the text using the machine-learning classifier, the score being indicative of the determined level of abusiveness; and
determining, by the computing system, the prediction for the text by comparing the score to one or more thresholds indicative of varying levels of abusiveness.

4. The computer-implemented method of claim 3, wherein repetitive text and overly aggressive text are both indicative of a lower level of abusiveness.

5. The computer-implemented method of claim 3, wherein:
the computing system obtains the text while a user is typing the text and before the text has been published at an online discussion system; and
when the score is greater than a writing threshold, the recommended action is a suggestion for the user to revise the text prior to its publication at the online discussion system.

6. The computer-implemented method of claim 3, wherein:
the computing system obtains the text before it loads at the computing device; and
when the score is greater than a viewing threshold, the recommended action is for the text to be hidden.

7. The computer-implemented method of claim 3, wherein:
the recommended action is with respect to publishing the text, and
the computing system obtains the text when it is submitted by its author for publishing at an online discussion system; and, further comprising:
based on the score and a publication threshold indicative of a level of abusiveness for publication without moderator review, selectively publishing, by the computing system, the text at the online discussion system.

8. The computer-implemented method of claim 7, further comprising:
when the score is less than or equal to the publication threshold, publishing, by the computing system, the text at the online discussion system;
when the score is greater than the publication threshold, outputting, from the computing system and to a computing device associated with the a moderator of the online discussion system, the text; and
selectively publishing, by the computing system, the text at the online discussion system based on a response from the computing device.

9. The computer-implemented method of claim 1, further comprising:
obtaining, by the computing system, feedback regarding an accuracy of the determined level of abusiveness; and
updating, by the server, the machine-learning classifier based on the feedback.

10. The computer-implemented method of claim 1, wherein training the machine-learning classifier involves utilizing a deep recurrent long short-term memory (LSTM) neural network.

11. A computing system having one or more processors and a non-transitory memory having instructions stored thereon that, when executed by the one or more processors, causes the computing system to perform operations comprising:
obtaining a vector-based language model associating elements of an unlabeled corpus that have similar meanings;
training a machine-learning classifier using the vector-based language model and a labeled corpus of text that has been annotated as having a particular level of abusiveness;
obtaining a text;
determining a prediction for the text using the machine-learning classifier, the prediction being indicative of a level of abusiveness of the text; and
based on the level of abusiveness of the text, selectively outputting a recommended action with respect to the text.

12. The computing system of claim 11, wherein the vector-based language model utilizes at least one of word vectors and paragraph vectors.

13. The computing system of claim 11, wherein the operations further comprise:
determining a score for the text using the machine-learning classifier, the score being indicative of the determined level of abusiveness; and
determining the prediction for the text by comparing the score to one or more thresholds indicative of varying levels of abusiveness.

14. The computing system of claim 13, wherein repetitive text and overly aggressive text are both indicative of a lower level of abusiveness.

15. The computing system of claim 13, wherein:
the computing system obtains the text while a user is typing the text and before the text has been published at an online discussion system; and
when the score is greater than a writing threshold, the recommended action is a suggestion for the user to revise the text prior to its publication at the online discussion system.

16. The computing system of claim 13, wherein:
the computing system obtains the text before it loads at the computing device; and
when the score is greater than a viewing threshold, the recommended action is for the text to be hidden.

17. The computing system of claim 13, wherein:
the recommended action is with respect to publishing of the text,
the computing system obtains the text when it is submitted by its author for publishing at an online discussion system; and, wherein the operations further comprise:
based on the score and a publication threshold indicative of a level of abusiveness for publication without moderator review, selectively publishing the text at the online discussion system.

18. The computing system of claim 17, wherein the operations further comprise:
when the score is less than or equal to the publication threshold, publishing, by the computing system, the text at the online discussion system;
when the score is greater than the publication threshold, outputting the text to a computing device associated with a moderator of the online discussion system; and
selectively publishing the text at the online discussion system based on a response from the computing device.

19. The computing system of claim 11, wherein the operations further comprise:
obtaining feedback regarding an accuracy of the determined level of abusiveness; and
updating the machine-learning classifier based on the feedback.

20. The computing system of claim 11, wherein training the machine-learning classifier involves utilizing a deep recurrent long short-term memory (LSTM) neural network.
